(19) United States
(12) Patent Application Publication
(10) Pub. No.: US 2021/0104030 A1
(43) Pub. Date: Apr. 8, 2021

(54) IMAGE INSPECTION DEVICE, IMAGE FORMING APPARATUS, INSPECTION REPORT CREATING PROGRAM, AND INSPECTION REPORT

(71) Applicant: KONICA MINOLTA, INC., Tokyo (JP)

(72) Inventors: Jun ITOU, Tokyo (JP); Daisuke GENDA, Kawasaki-shi (JP); Yasushi TSUE, Tokyo (JP)

(73) Assignee: KONICA MINOLTA, INC., Tokyo (JP)

(21) Appl. No.: 17/010,240

(22) Filed: Sep. 2, 2020

(30) Foreign Application Priority Data
Oct. 4, 2019 (JP) 2019-184048

(51) Int. Cl. G06T 7/00; G01N 21/88

(52) U.S. Cl. CPC G06T 7/001; G06T 2207/30204; G01N 21/8851; G01N 21/8806

(57) ABSTRACT

An image inspection device which makes it easy to recognize a defect in an image formed on a recording medium, through an image display. The image inspection device includes an inspection report creating section for creating an inspection report which gives an inspection image read from a recording medium a mark indicating a defect generated in the inspection image. When the defect has a directional component, the inspection report creating section creates an inspection report which gives a mark indicating the direction of extension of the defect at a position where the defect has been generated in the inspection image.

### CROSS-REFERENCE TO RELATED APPLICATIONS

The entire disclosure of Japanese Patent Application No. 2019-184048, filed on Oct. 4, 2019, is incorporated herein by reference in its entirety.

### BACKGROUND

### Technological Field

The present invention relates to an image inspection device, image forming apparatus, inspection report creating program, and inspection report.

### Description of the Related Art

Among image forming apparatuses which form an image on a recording medium in the form of a sheet, some are provided with an image inspection device which detects a defect in the formed image. One of the techniques related to such an image inspection device is disclosed in Patent Literature 1 (JP-A-1996-281920). Patent Literature 1 describes that an inspection to detect a defect is made by comparing a reference image and an inspection image in the defect judgment part of a processing unit and when a defect is generated, the part of the defect is enclosed and displayed.

### CITATION LIST

### Patent Literature

Patent Literature 1: JP-A-1996-281920

### SUMMARY

Image defects include defects which have a directional component, such as a streak, band or unevenness. However, in an image display in which the part of a defect is enclosed, when a plurality of defects having a directional component extend in different directions, it is difficult to recognize the direction of extension of each defect. For this reason, in order to determine whether the inspection image is good or not, in some cases it is necessary to make a final inspection of the real image.

Therefore, the present invention has an object to provide an image inspection device, an image forming apparatus, an inspection report creating program, and an inspection report which make it easy to recognize a defect having a directional component, which is generated in an image formed on a recording medium, through an image display.

In order to achieve the abovementioned object, according to an aspect of the present invention, an image inspection device reflecting one aspect of the present invention comprises: an inspection report creating section for creating an inspection report which gives an inspection image read from a recording medium a mark indicating a defect generated in the inspection image. When the defect has a directional component, the inspection report creating section creates an inspection report which gives the mark indicating a direction of extension of the defect at a position where the defect has been generated in the inspection image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view which shows the general configuration of an image forming apparatus according to an embodiment of the present invention;

FIG. 2 is a block diagram of the apparatus main unit;

FIG. 3 is a block diagram of the image inspection device according to the embodiment of the present invention;

FIG. 4 is a view which shows the mechanical structure of the image inspection device according to the embodiment of the present invention;

FIG. 5 is a functional structure diagram of the image inspection device according to the embodiment of the present invention;

FIG. 6 is a flowchart which shows the method for creating an inspection report to be carried out according to an inspection report creating program according to the present invention;

FIG. 7 is a view which shows an example of an inspection image for explanation of the method for creating an inspection report;

FIG. 8 is a view which shows an example of marks generated according to the inspection report creating program;

FIG. 9 is a view which shows an example of an inspection report created according to the inspection report creating program (Example 1); and

FIG. 10 is a view which shows an example of an inspection report created according to the inspection report creating program (Example 2).

### DETAILED DESCRIPTION OF EMBODIMENTS

Hereinafter, one or more embodiments of the present invention will be described with reference to the drawings. However, the scope of the invention is not limited to the disclosed embodiments.

<General Configuration of an Image Forming Apparatus According to an Embodiment>

FIG. 1 is a schematic view which shows the general configuration of an image forming apparatus 1 according to an embodiment of the present invention. The image forming apparatus 1 shown in the figure includes an apparatus main unit 100, a relay unit 200, an image inspection device 300, a purge unit 400, and a finisher 500. In the image forming apparatus 1, the image inspection device 300 is structurally characteristic. Next, these components of the image forming apparatus 1 will be described, starting with the apparatus main unit 100.

<Apparatus main unit 100>

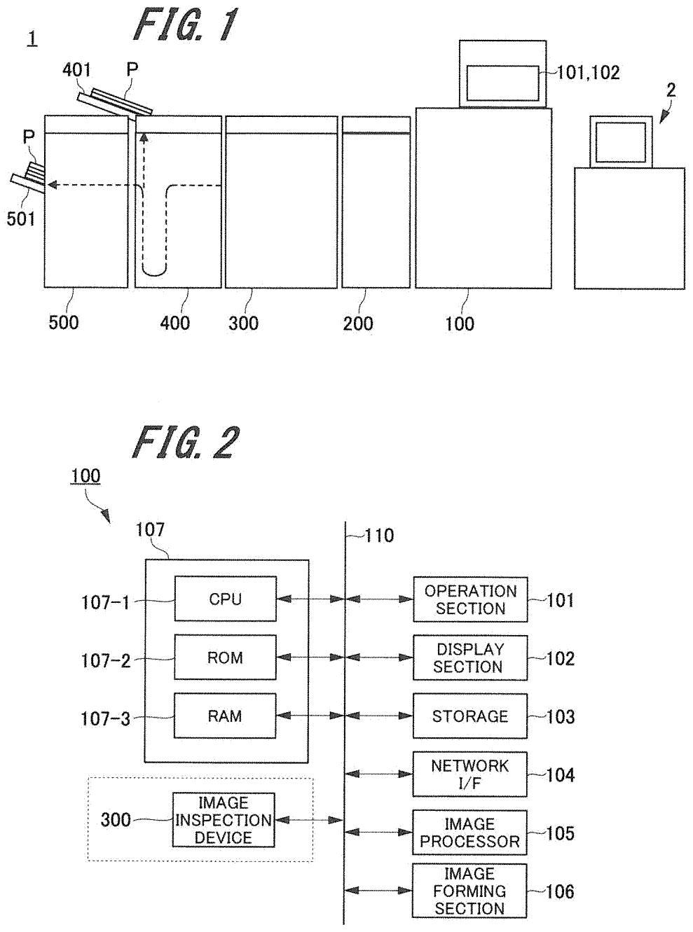

FIG. 2 is a block diagram of the apparatus main unit 100. As shown in FIGS. 1 and 2, the apparatus main unit 100 includes an operation section 101, a display section 102, a storage 103, a network interface 104, an image processor 105, an image forming section 106, and a controller 107. These components are mutually connected by a bus 110 and further connected to the image inspection device 300. Next, these components will be described.

[Operation section 101]

The operation section 101 is used to enter settings for the job to be performed using the apparatus main unit 100. The operation section 101 may be a touch panel integrated with the display section 102 which will be described next and constitutes an operation panel together with the display section 102. The operation section 101 may be an external device 2 such as a personal computer or printer controller, which can make communication for reception and transmission of data with the apparatus main unit 100.

[Display section 102]

The display section 102 displays the content of operation performed with the operation section 101. In addition, the display section 102 displays an inspection report created by the image inspection device 300 which will be described later.

[Storage 103]

The storage 103 is a nonvolatile storage unit, such as a hard disk drive, which stores an image forming program to form an image, image data sent from a printer controller as the external device 2, and image data for printing which is created by the image processor 105. The image data should be image data for printing which is rasterized by the printer controller as the external device 2.

[Network interface 104]

The network interface 104 is used for reception and transmission of data, for example, between the apparatus main unit 100 and the external device 2.

[Image processor 105]

The image processor 105 processes the image data received from the printer controller as the external device 2. Processing tasks which the image processor 105 performs are, for example, scaling (enlargement/reduction) and density unevenness correction for each device. The image processor 105 is also a functional part which functions when the image processing program, for example, stored in the storage 103 or another storage is executed by the controller 107 which will be described later.

[Image forming section 106]

The image forming section 106 forms an image on the main surface of a recording medium P in the form of a sheet by printing according to an instruction from the controller 107 and the image forming program stored in the storage 103. For example, when the image forming section 106 adopts an electrophotographic method, the image forming section 106 includes a medium transportation path, an intermediate transfer drum around which toner image forming units are arranged, and a fixing section, and forms a toner image on the main surface of the recording medium P transported along the medium transportation path.

[Controller 107]

The controller 107 controls operation of various components of the apparatus main unit 100 according to operation performed with the operation section 101 and a signal received from the external device 2 connected to the apparatus main unit 100 and performs processing according to the program stored in the storage 103. The controller 107 is a computing machine. The computing machine is hardware which is used as a so-called computer. The computing machine includes a CPU (Central Processing Unit) 107-1, a ROM (Read Only Memory) 107-2, and a RAM (Random Access Memory) 107-3.

Particularly the controller 107 causes the display section 102 to display the inspection report created by the image inspection device 300 which will be described later.

<Relay unit 200>

The relay unit 200 changes the transportation speed of the recording medium P on which an image has been formed by the apparatus main unit 100 and sends the recording medium P to the next device, or the image inspection device 300.

<Image inspection device 300>

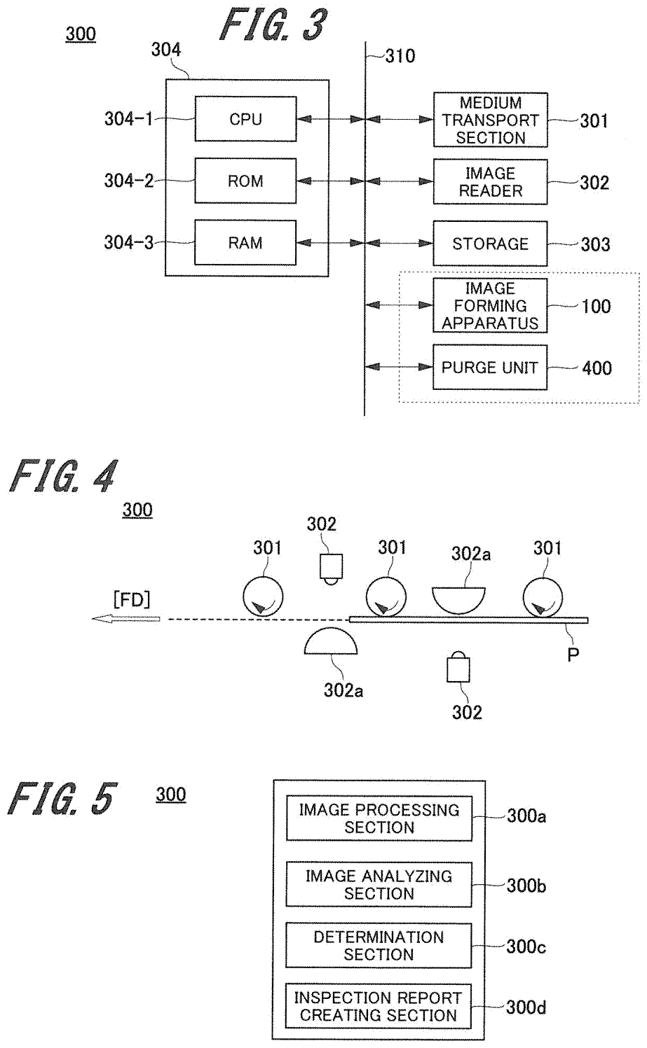

The image inspection device 300 inspects the image formed on the main surface of the recording medium P by the apparatus main unit 100. FIG. 3 is a block diagram of the image inspection device 300 according to the embodiment of the present invention. FIG. 4 is a view which shows the mechanical structure of the image inspection device 300. As shown in FIGS. 3 and 4, the image inspection device 300 includes a medium transport section 301, an image reader 302, a storage 303, and a controller 304. These components are mutually connected by a bus 310 and further connected to the apparatus main unit 100 and the purge unit 400. Next, these components of the image inspection device 300 will be described.

[Medium transport section 301]

The medium transport section 301 is a mechanical component which transports the recording medium P sent at a given speed from the relay unit 200 (see FIG. 1) toward a given transportation direction (FD) at a given speed. For example, the medium transport section 301 includes a plurality of conveyor rollers.

[Image reader 302]

The image reader 302 is a mechanical component to take an image of the main surface of the recording medium P transported by the medium transport section 301. The image reader 302 may be a line sensor in which imaging elements are arranged in the direction perpendicular to the transportation direction [FD] and an imaging element may be a CCD (Charge Coupled Device) or another kind of device.

The image reader 302 is located on each side of the recording medium P transported by the medium transport section 301 and reads the image on the main surface of the recording medium P on each side.

Furthermore, a plate-like shading member 302a is located opposite to each image reader 302 in order to detect white or black as a reference color for correction of non-uniformity of the optical system of the image reader 302 or pixel output non-uniformity of imaging elements (so-called shading correction).

[Storage 303]

The storage 303 is, for example, a nonvolatile storage device such as a hard disk drive, which stores the inspection image (image for inspection) acquired by the image reader 302, a reference image, and an image inspection program. Here, the reference image is an image which serves as a reference for the inspection image and is determined as defect-free. The reference image should be an image which is entered from the external device 2, for example, through the network interface 104.

The image inspection program includes a determination program to determine whether the inspection image is good or not, and an inspection report creating program. The determination program determines whether the inspection image is good or not, according to the result of comparison between the inspection image acquired by the image reader 302 and the reference image stored in the storage 303. The inspection report creating program creates an inspection report which shows the result of inspection based on the comparison between the inspection image acquired by the image reader 302 and the reference image stored in the storage 303. This embodiment is characterized by the inspection report creating program and details of the inspection report creating program will be given in the explanation of the method for creating an inspection report, which will be given later.

[Controller 304]

The controller 304 not only controls operation of each mechanical component of the image inspection device 300 but also performs processing according to the program stored in the storage 303. The controller 304 is a computing machine. The computing machine is hardware which is used as a so-called computer. The computing machine includes a CPU (Central Processing Unit) 304-1, a ROM (Read Only Memory) 304-2, and a

RAM (Random Access Memory) 304-3.

FIG. 5 is a functional structure diagram of the image inspection device 300 according to the embodiment of the present invention, which shows the functions to be performed when the controller 304 executes the program stored in the storage 303. As shown in FIG. 5, the image inspection device 300 includes the following functional sections: an image processing section 300a, an image analyzing section 300b, a determination section 300c, and an inspection report creating section 300d.

The image processing section 300a acquires data on the difference between the inspection image acquired by the image reader 302 and the reference image stored in the storage 303.

The image analyzing section 300b analyzes the difference data acquired by the image processing section 300a and detects a defect generated in the inspection image. The image analyzing section 300b detects a part with a difference intensity detected in the difference data, as a defect. For each detected defect, the image analyzing section 300b creates a profile which contains the magnitude of difference as the difference intensity of the defect, the area in which the defect has been generated, and other data.

The determination section 300c executes the determination program stored in the storage 303. According to the profile of each defect which has been created by the image analyzing section 300b, the determination section 300c determines whether the inspection image having the defect is good or not.

The inspection report creating section 300d executes the inspection report creating program stored in the storage 303. According to the profile of each defect which has been created by the image analyzing section 300b, the inspection report creating section 300d creates an inspection report which shows the result of inspection of the inspection image having the defect. The steps to create an inspection report which are carried out by the inspection report creating section 300d will be detailed in the explanation of the inspection report creating method which will be given later.

<Purge unit 400>

Referring back to FIG. 1, the purge unit 400 adjusts the transportation path for the recording medium P having passed through the image inspection device 300 according to the result of determination by the determination section 300c (see FIG. 5) of the image inspection device 300. Specifically, the purge unit 400 changes the transportation path for the recording medium P which the determination section 300c has determined as having a defect in the inspection image and delivers the recording medium P to a discard tray 401. The other sheets of recording medium P are transported to the next device, or the finisher 500.

<Finisher 500>

The finisher 500 performs a finishing process on the recording medium P transported from the purge unit 400 as necessary according to an instruction from the controller 107 (see FIG. 2) of the apparatus main unit 100 and delivers the recording medium P to a tray 501. The finishing process is, for example, creasing, slitting or perforating.

<Method for creating an inspection report>

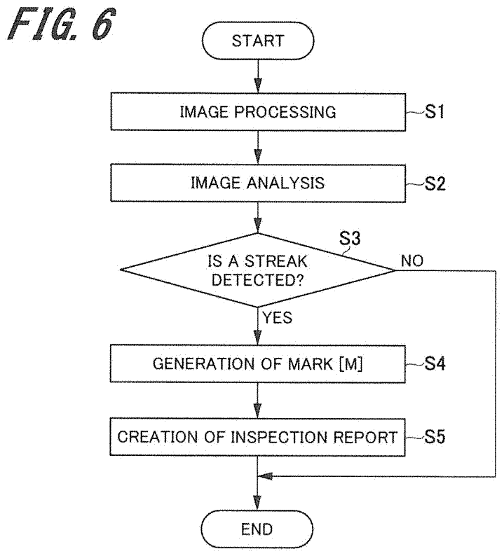

Next, the method for creating an inspection report which is carried out by the image inspection device 300 of the image forming apparatus 1 will be explained. FIG. 6 is a flowchart which shows the method for creating an inspection report which is carried out according to the inspection report creating program of the present invention. The flowchart shows the steps to carry out the inspection report creating method as part of the image inspection method according to the image inspection program. Next, according to the sequence shown in the flowchart of FIG. 6, the steps to create an inspection report will be explained referring to FIG. 5 and other figures as necessary.

<Step S1>

At Step S1, the image processing section 300a acquires the image read from the recording medium P by the image reader 302 as an inspection image and obtains data on the difference between the acquired inspection image and the reference image stored in the storage 303.

<Step S2>

At Step S2, the image analyzing section 300b analyzes the difference data obtained by the image processing section 300a and detects a part with a difference intensity detected in the difference data, as a defect generated in the inspection image. Then, for each detected defect, the image analyzing section 300b creates a profile which contains the magnitude of difference as the difference intensity of the defect, the area in which the defect has been generated, and other data.

<Step S3>

At Step S3, according to the profiles of defects which have been created by the image analyzing section 300b, the inspection report creating section 300d determines whether among the defects there is a defect having a directional component or not. Here, a defect having a directional component means a part in the difference data in which difference intensities are continuously detected in a series of addresses in one direction on the inspection image. In other words, a defect having a directional component is a defect called “streak”, “band” or “unevenness” or a defect which extends in one direction. Here, “one direction on the inspection image” means either the transportation direction [FD] of the recording medium P or the direction [CD] which is perpendicular to the transportation direction.

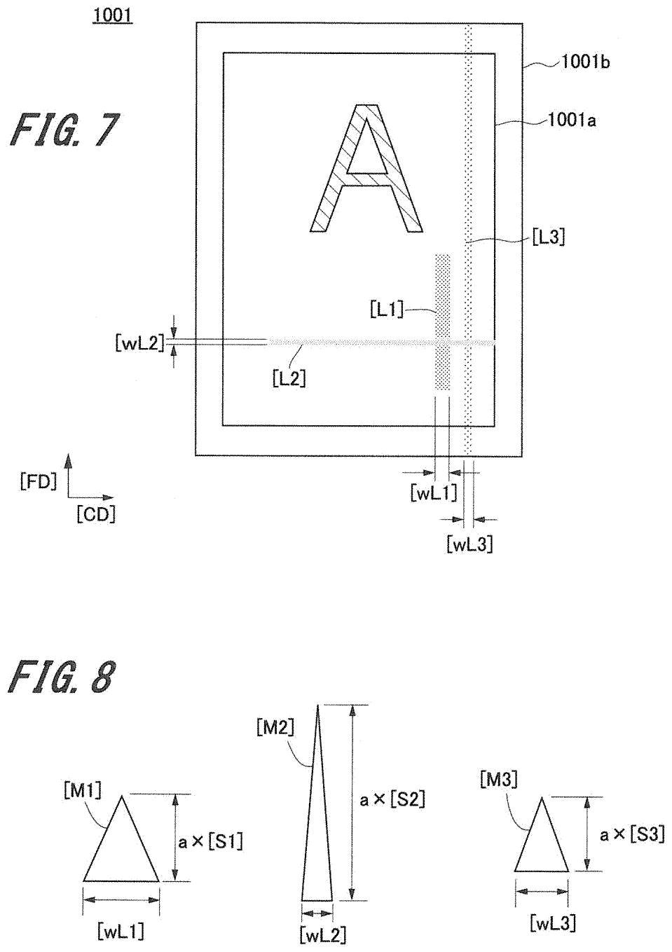

FIG. 7 is a view which shows an example of an inspection image 1001 for explanation of the method for creating an inspection report. The inspection image 1001 has an image area 1001a and an imaging area 1001b larger than the image area 1001a. The image area 1001a is an area in which an image is formed by the apparatus main unit 100 (see FIG. 1). In this example, a monochrome background and an alphabetic character are formed in the image area 1001a. The inspection image 1001 has three defects [L1] to [L3], each having a directional component as mentioned above. The three defects [L1] to [L3] are the first defect [L1] and third defect [L3] which extend in the transportation direction [FD], and the second defect [L2] which extends in the perpendicular direction [CD].

The inspection report creating section 300d proceeds to the next step S4 when it is determined that there is a defect having a directional component (YES), according to the profiles of defects as created by the image analyzing section 300b. On the other hand, when it is determined that there is no defect having a directional component (NO), the processing sequence is ended.

<Step S4>

At Step S4, the inspection report creating section 300d generates a mark [M] for each of the defects [L1] to [L3] having a direction component according to the profiles of the defects [L1] to [L3] having a directional component, among the profiles of defects which have been created by the image analyzing section 300b.

FIG. 8 is a view which shows an example of marks generated according to the inspection report creating program. As shown in FIGS. 7 and 8, the inspection report creating section 300d generates marks [Ml] to [M3] according to the profiles of the defects [L1] to [L3] having a directional component, in which widths [wL1] to [wL3] in the directions perpendicular to the directions of extension of the defects [L1] to [L3], and the difference intensities [S1] to [S3] of the defects are used as parameters.

For example, in the case of the first defect [L1], a triangle is generated as mark [M1] for the defect [L1], in which the triangle has a base with width [wL1] of the defect [L1] and a height as its difference intensity [S1] multiplied by coefficient (a). Similarly, in the case of the second defect [L2], a triangle is generated as mark [M2] for the defect [L2], in which the triangle has a base with width [wL2] of the defect [L2] and a height as its difference intensity [S2] multiplied by coefficient (a). Similarly, in the case of the third defect [L3], a triangle is generated as mark [M3] for the defect [L3], in which the triangle has a base with width [wL3] of the defect [L3] and a height as its difference intensity [S3] multiplied by coefficient (a).

The triangular marks [M1] to [M3] generated here may be isosceles triangles like the ones shown in the figure, but the marks are not so limited. For example, the marks may be right-angled triangles. However, it is desirable that the marks should be almost isosceles triangles because the width and height of an isosceles triangle are easy to recognize.

<Step S5>

At Step S5, the inspection report creating section 300d creates an inspection report in which the marks [M1] to [M3] generated at Step S4 are superimposed on the inspection image 1001.

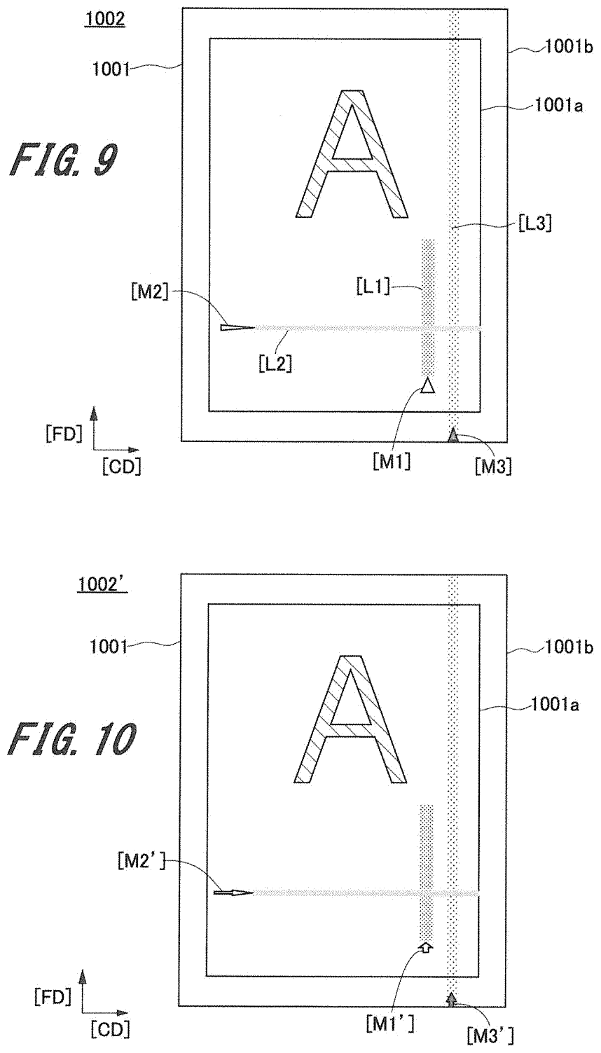

FIG. 9 is a view which shows an example of an inspection report 1002 created according to the inspection report creating program (Example 1). As shown in FIG. 9, the inspection report creating section 300d gives the inspection image 1001 the marks [L1] to [L3] in a manner that the widths of the marks [Ml] to [M3] coincide with the widths of the defects [L1] to [L3] having a directional component, respectively. Consequently, the height direction of each of the marks [M1] to [M3] is the same as the direction of extension of each of the defects [L1] to [L3].

In addition, preferably the marks [M1] to [M3] should be placed at the ends of the defects [L1] to [L3] having a directional component, respectively. In this case, the vertex of the triangle of each of the marks [Ml] to [M3] is oriented toward the direction of extension of each of the defects [L1] to [L3]. The marks [M1] to [M3] may overlap the ends of the defects [L1] to [L3] or may not overlap the ends. This makes it easier to grasp the area in which each of the defects [L1] to [L3] has been generated, than when the marks [M1] to [M3] are placed in the center of the defects [L1] to [L3] having a directional component.

The inspection report creating section 300d determines whether each of the defects [L1] to [L3] is due to the image reader 302 or not and selects the position and display color of each of the marks [M1] to [M3]. Here, a defect due to the image reader 302 means a defect which is generated due to a failure of the image reader 302 or a stain on the image reader 302.

In this example, the inspection report creating section 300d determines that the defect is due to the image reader 302 and compares the profile of each of the defects [L1] to [L3] as obtained through analysis by the image analyzing section 300b with the profile of the defect previously registered in the storage 303. Then, a defect which has the same profile as the registered defect, for example, the third defect [L3] is determined as a defect due to the image reader 302. Referring to FIG. 4, a defect due to the image reader 302 is detected by analysis of the image data which is obtained when the shading member 302a is read by the image reader 302 for shading correction.

Furthermore, according to the profiles of the defects [L1] to [L3], the inspection report creating section 300d may determine that a defect extending beyond the image area 1001a into the imaging area 1001b, like the third defect [L3], is a defect due to the image reader 302.

The inspection report creating section 300d places the corresponding mark [M3] for the defect due to the image reader 302 (the third defect [L3] in this example) in the imaging area 1001b outside the image area 1001a. In this example, the mark [M3] is placed in a manner to overlap the third defect [L3]. It is desirable that the marks [M1] and [M2] for the other defects [L1] and [L2] be placed within the image area 1001a. However, when the marks [M1] and [M2] are placed at the ends of the defects [L1] and [L2] having a directional component in a manner not to overlap the defects, the marks [M1] and [M2] may extend into the imaging area 1001b.

The inspection report creating section 300d shows the mark [L3] for the defect [L3] due to the image reader 302 in a different color from the color of the marks [M1] and [M2] for the other defects [L1] and [L2]. This makes it easy to distinguish between the defect [L3] due to the image reader 302 and the other defects [L1] and [L2].

The inspection report 1002 created as explained above is stored, for example, in the storage 303 of the image inspection device 300. Referring to FIG. 1, the inspection report 1002 stored in the storage 303 of the image inspection device 300 is displayed on the display section 102 of the apparatus main unit 100 according to an instruction from the operation section 101 of the apparatus main unit 100.

Although not explained here, the inspection report creating section 300d may not only generate marks for defects having a directional component such as the defects [L1] to [L3], but also generate various marks to indicate other types of defects and superimpose the marks on the inspection report 1002. Here, “other types of defects” include point-like defects with a low toner density which are called “fireflies” and toner spots printed in an unwanted area which are called “spots”.

<<Advantageous effects of the embodiment>>

According to the abovementioned embodiment, the inspection report 1002, which gives the marks [M1] to [M3] indicating the directional components of the defects [L1] to [L3] to the defects [L1] to [L3] generated in the inspection image 1001 respectively, is created. Therefore, the defects [L1] to [L3] having a directional component, which are difficult to recognize in the image formed on the recording medium P, can be easily recognized by checking the inspection report 1002 as a displayed image.

As a consequence, the operator can determine whether the image formed on the recording medium P is good or not, simply by checking the inspection report 1002 as a displayed image without checking the real recording medium P on which the image has been formed. Referring to FIG. 1, regarding the recording medium P delivered to the discard tray 401, since whether the formed image is good or not can be determined without the need to check the real recording medium P, it is easy to do the following work: pull the recording medium P corresponding to the inspection image 1001 determined as non-defective, out of the discard tray 401 to treat it as a non-defective product.

<<Variation>>

The abovementioned method for creating an inspection report assumes that the marks [M1] to [M3] generated by the inspection report creating section 300d at Step S4 are triangular. However, the marks generated by the inspection report creating section 300d are not limited to triangles, provided that the marks have widths [wL1] to [wL3] in the direction perpendicular to the direction of extension of the defects [L1] to [L3], and a height based on difference intensities [S1] to [S3], respectively.

FIG. 10 shows an example of an inspection report 1002′ created according to the inspection report creating program (Example 2). As shown in the figure, the marks [M1′] to [M3′] generated by the inspection report creating section 300d may be arrows.

For example, in the case of the first defect [L1], an arrow is generated as mark [M1′] for the defect [L1], in which the mark has a base with width [wL1] of the defect and a height as the difference intensity [S1] multiplied by coefficient (a). Similarly, in the case of the second defect [L2] and third defect [L3], arrows with the width and height corresponding to the defects are generated as marks [M2′] and [M3′], respectively.

For the marks [M1′] to [M3′] as arrows, the ratio of the width and height of the arrow shaft and head should be previously determined.

This variation can also bring about the same advantageous effects as the abovementioned embodiment.

In the image forming apparatus 1 described in reference to FIG. 1, the image inspection device 300 is provided as a device separate from the apparatus main unit 100 which forms an image. However, instead, the image inspection device 300 may be built in the apparatus main unit 100. In this case, the controller 107 (see FIG. 2) of the apparatus main unit 100 may be the same controller 304 (see FIG. 3) of the image inspection device 300.

Furthermore, in the abovementioned embodiment, after the inspection report creating section 300d generates marks [M] at Step S4, it gives the generated marks [M] to the inspection image at Step S5. However, the inspection report creating section 300d may generate marks [M] over the inspection image.

Although embodiments of the present invention have been described and illustrated in detail, the disclosed embodiments are made for purposes of illustration and example only and not limitation The scope of the present invention should be interpreted by terms of the appended claims

### Reference Signs List

1 . . . image forming apparatus,

300 . . . image inspection device,

300a . . . image processing section,

300b . . . image analyzing section,

300d . . . inspection report creating section,

302 . . . image reader,

303 . . . storage,

304 . . . controller,

1001 . . . inspection image,

1001a . . . image area,

1001b . . . imaging area,

1002, 1002′ . . . inspection report,

[L1] to [L3] . . . defects,

[M1] to [M3], [M1′] to [M3′] . . . marks

1. An image inspection device, comprising:
an inspection report creating section for creating an inspection report which gives an inspection image read from a recording medium a mark indicating a defect generated in the inspection image, wherein
when the defect has a directional component, the inspection report creating section creates an inspection report which gives the mark indicating a direction of extension of the defect at a position where the defect has been generated in the inspection image.

2. The image inspection device according to claim 1, wherein the inspection report creating section generates the mark whose shape has a width in a direction perpendicular to the direction of extension of the defect and a height corresponding to an intensity of the defect.

3. The image inspection device according to claim 1, wherein the mark is triangular.

4. The image inspection device according to claim 1, wherein the mark is arrow-shaped.

5. The image inspection device according to claim 1, further comprising:
an image reader which reads an image formed on the recording medium;
an image processing section which compares an inspection image read by the image reader and a reference image as a reference for the inspection image; and
an image analyzing section which detects a defect generated in the inspection image and a defect type according to a result of comparison by the image processing section.

6. The image inspection device according to claim 5, further comprising:
a storage which stores a profile of the defect having a directional component, which is generated in the inspection image due to the image reader, wherein
when the image analyzing section detects the defect having the directional component, the inspection report creating section refers to the profile of the defect as stored in the storage, determines whether the detected defect is due to the image reader or not, and changes display color of the mark depending on whether the defect is due to the image reader or not.

7. The image inspection device according to claim 6, wherein the inspection report creating section places the mark given to the defect due to the image reader, outside an image formation area of the inspection image.

8. The image inspection device according to claim 1, wherein the report creating section gives the mark to an end of the defect in the direction of extension of the defect.

9. An image forming apparatus comprising the image inspection device according to claim 1.

10. A non-transitory computer-readable recording medium storing an inspection report creating program causing a computer to create an inspection report which gives an inspection image read from a recording medium a mark indicating a defect generated in the inspection image, wherein
when the defect has a directional component, a controller of an image inspection device creates an inspection report which gives a mark indicating a direction of the defect, at a position where the defect has been generated in the inspection image.

11. An inspection report created by the inspection report creating section of the image inspection device according to claim 1.
